(19) United States
(12) Patent Application Publication
(10) Pub. No.: US 2008/0170209 A1
(43) Pub. Date: Jul. 17, 2008

(54) Image Display System, Image Output System, and Image Display Method

(75) Inventor: Hiroshi MIDORIKAWA, Shiojiri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/942,302

(22) Filed: Nov. 19, 2007

(30) Foreign Application Priority Data
Jan. 12, 2007 (JP) 2007-005117
Sep. 26, 2007 (JP) 2007-248461

(51) Int. Cl. G03B 21/00; G09G 3/36

(52) U.S. Cl. 353/122; 345/87

(57) ABSTRACT

An image display system includes an image output device for outputting image information, an image display device for displaying an image corresponding to the image information, and a transmission section that connects the image output device and the image display device to each other in a manner capable of transmission of information, wherein the image output device includes an output device-side display section that displays an image corresponding to the image information, an output device-side control section that controls the output device-side display section, and an operation section that allows input of an output device-side adjustment information for adjusting a display condition of an image displayed by the output device-side display section, and outputs the output device-side adjusting information to the output device-side control section, the output device-side control section having an output device-side display adjustment section that makes a display condition of an image displayed by the output device-side display section be adjusted in accordance with the output device-side adjustment information, and a transmission control section that generates display device-side adjustment information for adjusting a display condition of an image displayed by the image display device in accordance with the display condition adjusted by the output device-side display adjustment section in accordance with the output device-side adjustment information, and makes the display device-side adjustment information be transmitted by the transmission section, and the image display device includes an display device-side display section that displays an image corresponding to the image information, and a display device-side control section that controls the display device-side display section, the display device-side control section having a display device-side display adjustment section that, in response to reception of the display device-side adjustment information, makes a display condition of an image displayed by the display device-side display section be adjusted in accordance with the display device-side adjustment information.

### BACKGROUND

1. Technical Field

The present invention relates to an image display system, an image output system, and an image display method.

2. Related Art

In the past, there is known a projector which modulates light emitted from a light source in accordance with image information to form an optical image, and enlargedly projects the optical image on a screen or the like to display the image. Since such a projector is used in various environments and for various purposes such as a presentation in a conference, an academic conference, or an exhibition, the projector is arranged to be capable of adjusting display conditions such as luminance, contrast, colors, or image size in the image displayed on the screen and so on (e.g., JP-A-2005-192188 (hereinafter referred to as Document 11).

In the projector described in the Document 1, the user of the projector inputs parameters such as luminance in an image displayed on a screen or the like by operating operation buttons provided to a remote controller or the main body of the projector. Further, an adjustment of the display condition can be performed by executing an image quality adjusting process on the image information based on the parameters.

Incidentally, when a presentation is performed using the projector, the presentation is performed with an image output device such as a laptop personal computer (PC) for outputting the image information connected to the projector.

It should be noted here that in the projector described in the Document 1, in the case in which the presenter of the presentation tries to adjust the display conditions in the display image of the presentation during the execution of the presentation, the presenter needs to operate the operation buttons provided to the remote controller or the main body of the projector.

However, since the presenter of the presentation performs the presentation near the laptop PC or the screen, it is difficult for the presenter to operate the operation buttons provided to the main body of the projector. Further, in some cases, the presenter does not have the remote controller in his or her hand. Therefore, there arises a problem that it is not easy for the presenter to adjust the display conditions in the display image of the presentation.

### SUMMARY

An advantage of some aspects of the invention is to provide an image display system, an image output device, and an image display method allowing the presenter to easily adjust the display conditions in the display image of the presentation.

An image display system according to an aspect of the invention includes an image output device for outputting image information, an image display device for displaying an image corresponding to the image information, and a transmission section that connects the image output device and the image display device to each other in a manner capable of transmission of information, wherein the image output device includes an output device-side display section that displays an image corresponding to the image information, an output device-side control section that controls the output device-side display section, and an operation section that allows input of an output device-side adjustment information for adjusting a display condition of an image displayed by the output device-side display section, and outputs the output device-side adjusting information to the output device-side control section, the output device-side control section having an output device-side display adjustment section that makes a display condition of an image displayed by the output device-side display section be adjusted in accordance with the output device-side adjustment information, and a transmission control section that generates display device-side adjustment information for adjusting a display condition of an image displayed by the image display device in accordance with the display condition adjusted by the output device-side display adjustment section in accordance with the output device-side adjustment information, and makes the display device-side adjustment information be transmitted by the transmission section, and the image display device includes an display device-side display section that displays an image corresponding to the image information, and a display device-side control section that controls the display device-side display section, the display device-side control section having a display device-side display adjustment section that, in response to reception of the display device-side adjustment information, makes a display condition of an image displayed by the display device-side display section be adjusted in accordance with the display device-side adjustment information.

According to such a configuration, when the user of the image output device operates the operation section to input the output device-side adjustment information for adjusting the display condition of the image displayed by the output device-side display section, the transmission control section generates the display device-side adjustment information for adjusting the display condition of the image displayed by the display device-side display section in accordance with the display condition adjusted by the output device-side display adjustment section in accordance with the output device-side adjustment information, and makes the display device-side adjustment information be transmitted by the transmission section. Then, the display device-side display adjustment section makes the display condition of the image displayed by the display device-side display section be adjusted in accordance with the display device-side adjustment information.

Therefore, by operating the operation section to adjust the display condition of the image displayed by the output device-side display section, the user of the image output device can adjust the display condition of the image displayed by the display device-side display section in conjunction therewith.

Specifically, in the aspect of the invention, if, for example, a projection system adopting a laptop PC as the image output device and a projector as the image display device is configured, even when the presenter of a presentation performs the presentation near the laptop PC or a screen, the presenter can easily adjust the display condition in the display image of the presentation during execution of the presentation without operating operation buttons provided to the main body of the projector or a remote controller. Further, since the presenter needs only to perform the adjustment of the display condition in the display image of the laptop PC, there is no need for learning an additional operation, thus the projection system is accessible for the presenter.

In this aspect of the invention it is preferable that the transmission control section generates the display device-side adjustment information in accordance win the output device-side adjustment information for adjusting luminance, and makes the display device-side adjustment information be transmitted by the transmission section.

Since the presentations often performed in a dark environment, the presenters frequently adjust the luminance of the display images of the image display device during execution of the presentation. Therefore, according to such a configuration, the image display system according to the aspect of the invention can be applied with particular preference.

In this aspect of the invention, it is preferable that the image display device is a projector provided with a light source device, a light modulation device for modulating light emitted from the light source device in accordance with an image information to form an optical image, and a projection optical device for enlargedly, projecting the optical image thus formed.

According to such a configuration, the same function and advantage as in the image display system described above can be obtained.

Further, since the projector is often used for the presentations in conferences, academic conferences, or exhibitions, the invention can preferably be used.

An image output device according to another aspect of the invention is an image output device used for an image display system including the image output device for outputting the image information, an image display device for displaying an image corresponding to the image information, and a transmission section that connects the image output device and the image display device to each other in a manner capable of transmission of information including an output device-side display section that displays an image corresponding to the image information, an output device-side control section that controls the output device-side display section, and an operation section that allows input of an output device-side adjustment information for adjusting a display condition of an image displayed by the output device-side display section, and outputs the output device-side adjusting Information to the output device-side control section, the output device-side control section having an output device-side display adjustment section that makes a display condition of an image displayed by the output device-side di-splay section be adjusted in accordance with the output device-side adjustment information, and a transmission control section that generates display device-side adjustment information for adjusting a display condition of an image displayed by the image display device in accordance with the display condition adjusted by the output device-side display adjustment section in accordance with the output device-side adjustment information, and makes the display device-side adjustment information be transmitted by the transmission section.

According to such a configuration, the image output device can be used as a suitable device for the image display system described above.

An image display method according to another aspect of the invention includes (a) the step of providing an image display system including an image output device for outputting the image information, an image display device for displaying an image corresponding to the image information, and a transmission section that connects the image output device and the image display device to each other in a manner capable of transmission of information, (b) the step of the image output device adjusting a display condition of an image displayed by the image output device in accordance with output device-side adjustment Information in response to input of the output device-side adjustment information for adjusting a display condition of an image displayed by the image output device, (c) the step of the image output device generating display device-side adjustment information for adjusting a display condition of an image displayed by the image display device in accordance with the display condition adjusted in step (b) in accordance with the output device-side adjustment information, and transmitting the display device-side adjustment information by the transmission section, and (d) the step of the image display device adjusting a display condition of an image displayed by the image display device in accordance with the display device-side adjustment information in response to reception of the display device-side adjustment information.

According to such a configuration, the same function and advantage as in the image display system described above can be obtained.

### BRIEF DESCRIPTION OF THE DRAWINGS

The invention will now be described with reference to the accompanying drawings, wherein like numbers refer to like elements.

FIG. 1 is an outline view of a projection system according to one embodiment of the invention.

FIG. 2 is a block diagram showing a schematic configuration of a laptop PC according to the embodiment.

FIG. 3 is a block diagram showing a schematic configuration of a projector according to the embodiment.

FIG. 4 is a flowchart showing an operation of the projection system according to the embodiment.

### DESCRIPTION OF EXEMPLARY EMBODIMENTS

An embodiment of the invention will hereinafter be explained with reference to the accompanying drawings.

### Schematic Configuration of Projection System

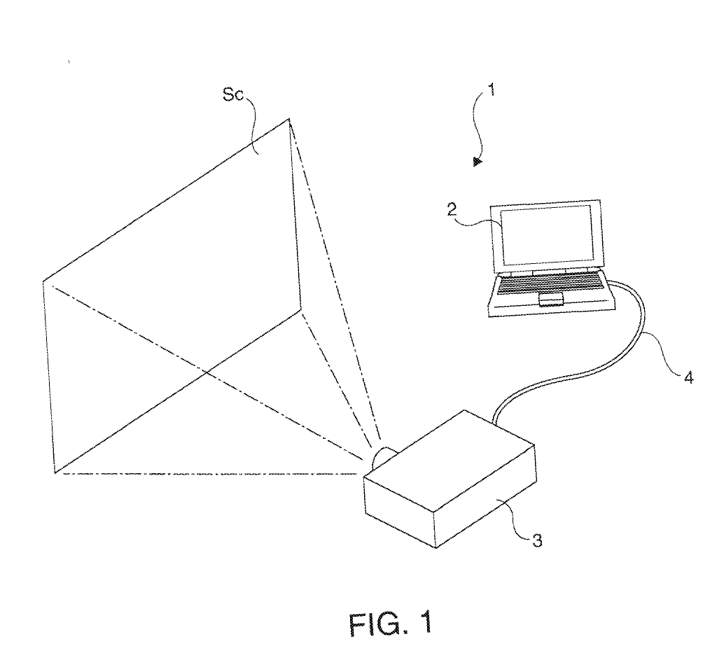

FIG. 1 is an outline view of a projection system 1 as the image display system.

As shown in FIG. 1, the projection system 1 is provided with a laptop PC 2 for outputting an image data signal (image information) a projector 3 for generating an optical image according to the image data signal output from the laptop PC 2 and projecting the optical image towards a screen Sc, and an image cable 4 for connecting the laptop PC 2 and the projector 3 to each other to transmit the image data signal output form the laptop PC 2 to the projector 3.

It should be noted that in response to the projector 3 projecting the optical image, the image (hereinafter referred to as a display image of the projector 3) corresponding to the image data is displayed on the screen Sc.

The image cable 4 is a cable connected in order for transmitting the image data signal, and is formed of an analog red/green/blue (hereinafter, RGB) cable. Further, the image data signal is transmitted as an analog RGB signal. It should be noted that the image cable 4 is not limited to be formed of the analog RGB cable, but can be formed, for example, of a composite cable or a digital RGB cable, one of which is preferably selected in accordance with the image data signal to be transmitted.

### Configuration of Laptop PC

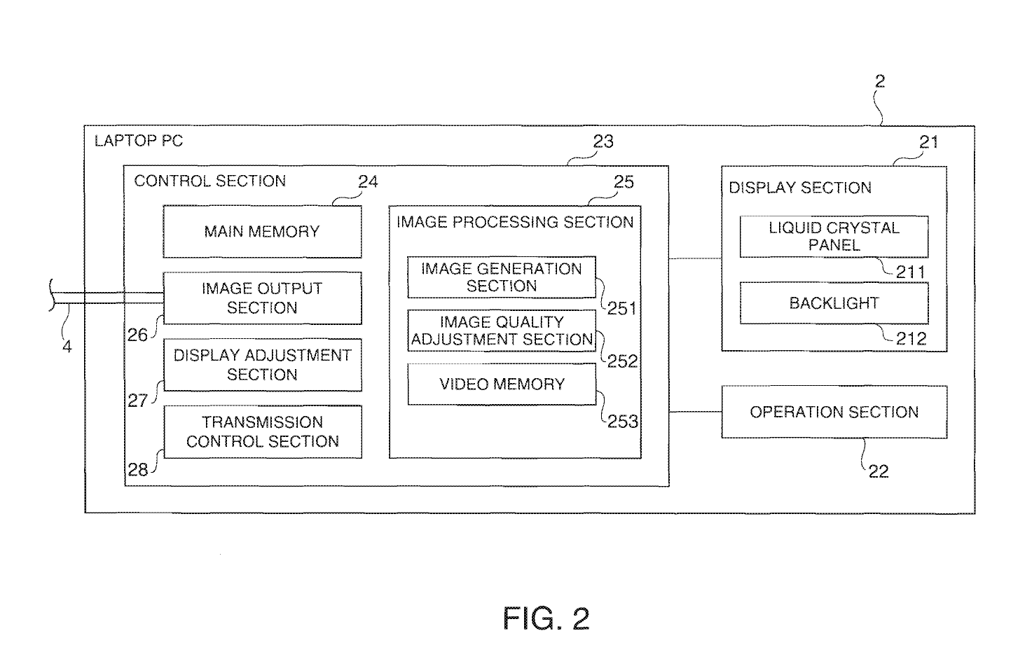

FIG. 2 is a block diagram showing a schematic configuration of the laptop PC 2.

As shown in FIG. 2, the laptop PC 2 as the image output device is mainly composed of a display section 21, an operation section 22, and a control section 23.

The display section 21 as an output device-side display section is provided with a liquid crystal panel 211 and a backlight 212.

The liquid crystal panel 211 is a transmissive liquid crystal panel and changes the arrangement of liquid crystal molecules encapsulated in liquid crystal cells (not shown) to transmit or block the light emitted from the back light 212, thereby displaying an image corresponding to the image data output from the control section 23. It should be noted that the backlight 212 is configured to be capable of adjusting the luminance of the light emitted by itself in accordance with a control signal from the control section 23.

The operation section 22 is, for example, a keyboard or a mouse, and has various operation buttons to be operated by the user of the laptop PC 2. Further, the operation section 22 is configured so that by operating the operation buttons, PC-side luminance information for adjusting the luminance in the image (hereinafter referred to as a display image of the laptop PC 2) displayed on the display section 21 and PC-side image quality information for adjusting the contrast, colors, an image size, and so on in the display image of the laptop PC 2 can be input. Further, the operation section 22 outputs to the control section 23 the PC-side luminance information and the PC-side image quality information thus input.

It should be noted that in the present embodiment, the explanation will be presented exemplifying the PC-side luminance information as the output device-side adjustment information.

Further, as a method of enabling the input of the PC-side luminance information by the operation section 22, there can be exemplified, for example, a method that a part of the operation buttons is assigned as a shortcut key for increasing or decreasing the luminance and the user of the lap top PC 2 operates the shortcut key, or a method that the user of the laptop PC 2 inputs the luminance value using a menu screen or the like.

The control section 23 as the output device-side control section is a section controlling the display section 21 as well as the laptop PC 2 as a whole, configured including, for example, a central processing unit (CPU), and, is provided with a main memory 24, an image processing section 25, an image output section 26, a display adjustment section 27 and a transmission control section 28 as shown in FIG. 2. These components 24 through 28 are configured to be connected to each other by a bus not shown in the drawings so as to be able to communicate necessary information.

The main memory 24 stores programs, data, and so on for executing predetermined processes in the image processing section 25, the display adjustment section 27, and so on. For example, background image data and character data such as a character or a picture for generating the image data, and the PC-side luminance information and the PC-side image quality information described above are stored. It should be noted that the control section 23 stores the PC-side luminance information and the PC-side image quality information output by the operation section 22 in the main memory 24.

The image processing section 25 is for executing the image processing, configured including, for example, a graphics processing unit (GPU), and is provided with an image generation section 251, an image quality adjustment section 252, and a video memory 253.

The image generation section 251 generates the image data by a frame corresponding to one frame of the screen from the background image data and the character data stored in the main memory 24.

The image quality adjustment section 252 executes the image processing based on the PC-side image quality information stored in the main memory 24 on the image data generated by the image generation section 251 to perform an adjustment of the image quality. Further, the image quality adjustment section 252 stores in the video memory 253 the image data on which the image processing is executed. It should be noted that the video memory 253 is a buffer for temporarily storing the image data.

Further, the image processing section 25 outputs the image data stored in the video memory 253 to the display section 21, and the liquid crystal panel 211 then displays the image corresponding to the image data.

The image output section 26 is configured including, for example, a GPU, and converts the image data stored in the video memory 253 into the image data signal to output it via the image cable 4. Further, the image output section 26 is configured to be able to transmit information utilizing Display Data Channel Command Interface (DDC/CI). It should be noted here that DDC/CI is a Video Electronics Standards Association (VESA) standard, and is capable of transmitting predetermined commands using a DDC line in an analog/digital RGB cable. Therefore, in the present embodiment, the transmission section is composed of the image cable 4 and the image output section 26.

When the PC-side luminance information is stored by the main memory 24, the display adjustment section 27 as the output device-side display adjustment section outputs a control signal according to the PC-side luminance information to the backlight 212. Then, the backlight 212 adjusts the luminance of the light emitted by itself in accordance with the control signal output from the display adjustment section 27. In other words, the display adjustment section 27 makes the backlight 212 adjust the luminance in the display image of the laptop PC 2.

When the PC-side luminance information is stored by the main memory 24, the transmission control section 28 generates, in accordance with the PC-side luminance information, projector-side luminance information (display device-side adjustment information) for adjusting the luminance in the display image of the projector 3 in accordance with the luminance adjusted by the display adjustment section 27. In the case, for example, in which the PC-side luminance information instructing to increase the luminance in the display image of the laptop PC 2 is input, the transmission control section 28 generates the projector-side luminance information for increasing the luminance in the display image of the projector 3, and in the case which the PC-side luminance information instructing to decrease the luminance in the display image of the laptop PC 2 is input, the transmission control section 28 generates the projector-side luminance information for decreasing the luminance in the display image of the projector 3.

Further, the transmission control section 23 makes the image output section 26 transmit the projector-side luminance information via the image cable 4. It should be noted that the projector-side luminance information is transmitted to the projector 3 using the DDC/CI described above.

### Configuration of Projector

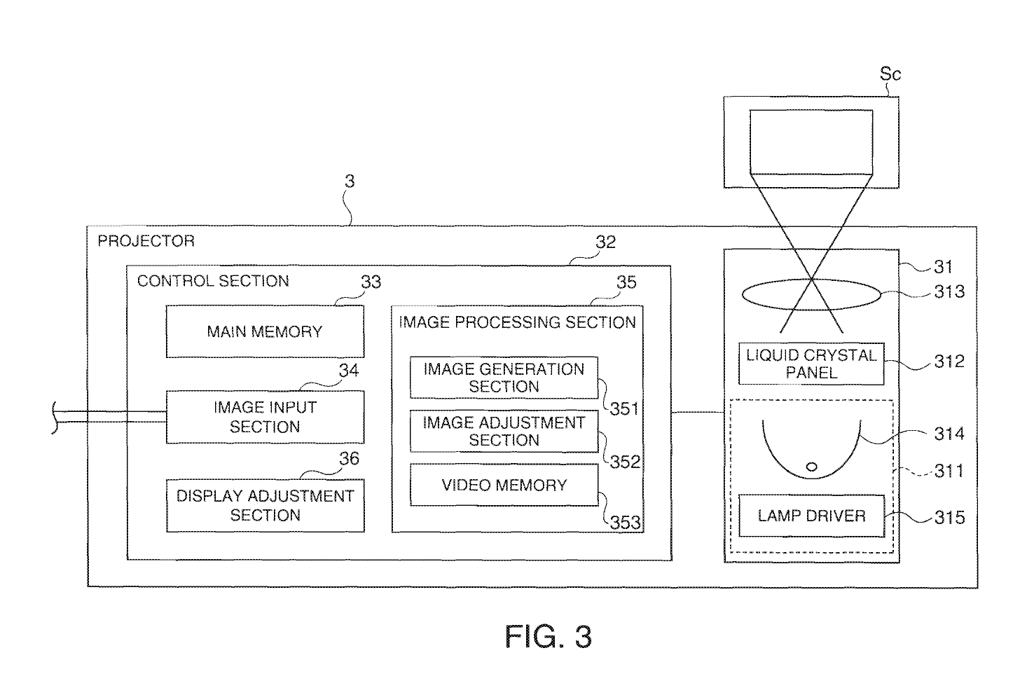

FIG. 3 is a block diagram showing a schematic configuration of the projector 3.

The projector 3 as the image display device is composed mainly of an image projection section 31 and a control section 32 as shown in FIG. 3.

The image projection section 31 as the display device-side display section forms an optical image corresponding to the image data output from the control section 32, and enlargedly projects the optical image on the screen Sc. Thus, the image corresponding to the image data is displayed on the screen Sc. As shown in FIG. 3, the image projection section 31 is provided with a light source device 311, a liquid crystal panel 312 as a light modulation device, and a projection optical device 313.

The light source device 311 is for outputting light towards the liquid crystal panel 312, and is provided with a light source lamp 314 and a lamp driver 315.

The light source lamp 314 is formed of a super high pressure mercury lamp. It should be noted that instead of the super high pressure mercury lamp, a discharge-type light source lamp such as a metal halide lamp or a xenon lamp can also be adopted. Furthers instead of the discharge-type light source lamp, various types of self-emission elements such as a light emitting diode, a laser diode, an organic EL elements or a silicon light emitting element can also be adopted.

The lamp driver 315 applies a drive voltage to the light source lamp 314 in accordance with the control signal from the control section 32 to drive the light source lamp 314. It should be noted that the light source lamp 314 can adjust the luminance of the light to be emitted by itself by adjusting the drive voltage applied by the lamp driver 315.

The liquid crystal panel 312 is a transmissive liquid crystal panel, and varies the arrangement of the liquid crystal molecules encapsulated in liquid crystal cells (omitted from the drawings) based on the drive signal from the control section 32 to transmit or block the light emitted from the light source lamp 314, thereby modulating the light to form an optical image in accordance with the image data, and emits the optical image towards the projection optical device 313.

The projection optical device 313 enlargedly projects the optical image emitted from the liquid crystal panel 312 towards the screen Sc.

It should be noted that, although omitted from the drawings, the projector 3 is provided with three liquid crystal panels 312 corresponding to three colors of R, G, and B, respectively. Further, the light source device 311 is provided with a color separator optical system for separating the light emitted from the light source lamp 314 into three colors of light. Further, the projection optical device 313 includes a combining optical system for generating an optical image representing a color image by combining the three colors of optical images. It should be noted that as the configuration of such an optical system, various typical configurations of the optical systems of the projectors can be used.

The control section 32 as the display device-side control section is a section for controlling the image projection section 31 as well as the projector 3 as a whole, configured including, for example, a CPU, and is provided with a main memory 33, an image input section 34, an image processing section 35, and a display adjustment section 36 as shown in FIG. 3. These components 33 through 35 are configured to be connected to each other by a bus not shown in the drawings so as to be able to communicate necessary information.

The main memory 33 stores programs, data, and so on for executing predetermined processes in the image processing section 35, the display adjustment section 36, and so on. For example, projector-side luminance information for adjusting the luminance in the display image of the projector 3, and projector-side image quality information for adjusting the contrast, the colors, and the image size in the display image of the projector 3 are stored.

It should be noted that the projector 3 is provided with an operation section (not shown) such as operation buttons provided to the main body thereof or a remote controller. Further, the operation section is configured so that by operating the operation buttons, the projector-side image quality information described above can be input, and outputs the projector-side image quality information to the control section 32. Then, the control section 32 stores the input projector-side image quality information in the main memory 33.

The image input section 34 inputs via the image cable 4 the image data signal output from the image output section 26. Further, the image input section 34 receives via the image cable 4 the projector-side luminance information out-out from the image output section 26. It should be noted that since the projector-side luminance information is transmitted using the DDC line of the image cable 4, the image input section 34 can obtain the image data signal and the projector-side luminance information separately from each other. Then, the image input section 34 outputs the image data signal to the image processing section 35, and stores the projector-side luminance information in the main memory 33.

The image processing section 35 is for executing the image processing, configured including, for example, a graphics processing unit (GPU), and is provided with an image generation section 351, an image quality adjustment section 352, and a video memory 353.

The image generation section 351 samples the image data signal output by the image input section 34 to generate the image data by a frame.

The image quality adjustment section 352 executes the image processing based on the projector-side image quality information stored in the main memory 33 on the image data generated by the image generation section 351 to perform an adjustment of the image quality. Further, the image quality adjustment section 352 stores in the video memory 353 the image data on which the image processing is executed.

Subsequently, the image processing section 35 outputs the image data stored in the video memory 353 to the image projection section 31, and the image projection section 31 forms the optical image corresponding to the image data stored in the video memory 353, and enlargedly projects the optical image on the screen Sc.

When the projector-side luminance information is stored in the main memory 33, namely the projector-side luminance information is received by the image input section 34, the display adjustment section 36 as the display device-side display adjustment section outputs the control signal corresponding to the projector-side luminance information to the lamp driver 315. Then, the amp driver 315 adjusts the drive voltage applied to the light source lamp 314 in accordance with the control signal output from the display adjustment section 36, thereby adjusting the luminance of the light emitted from the light source lamp 314. In other words, the display adjustment section 36 makes the lamp driver 315 adjust the luminance in the display image of the projector 3,

### Operation of Projection System

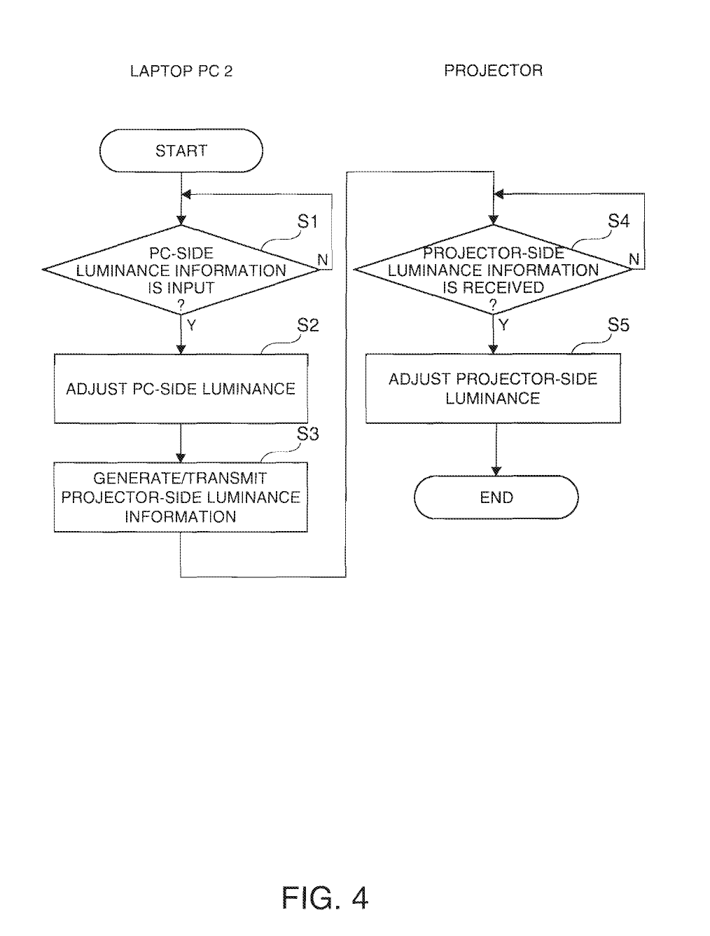

An operation of the projection system 1 will now be explained with reference to FIG. 4.

FIG. 4 is a flowchart showing an operation of the projection system 1.

It should be noted that in FIG. 4, the steps S1 through S3 in the left flowchart are executed by the laptop PC 2, and the steps S4 and S5 in the right flowchart are executed by the projector 3.

Firstly, when the operation buttons of the operation section 22 are operated by the user of the laptop PC 2 to input the PC-side luminance information for adjusting the luminance in the display image of the laptop PC 2, the operation section 22 outputs to the control section 23 the PC-side luminance information thus input (step S1).

In response to the operation section 22 outputting the PC-side luminance information, the control section 23 stores the PC-side luminance information to the main memory 24. Then the display adjustment section 27, in response to the main memory 24 storing the PC-side luminance information, makes the backlight 212 adjust the luminance in the display image of the laptop PC 2 in accordance with the PC-side luminance information (step S2: the output device-side display adjustment step).

Further, when the PC-side luminance information is stored by the main memory 24, the transmission control section 28 generates, in accordance with the PC-side luminance information, the projector-side luminance information for adjusting the luminance in the display image of the projector 3 in accordance with the luminance adjusted by the display adjustment section 27. Then, the transmission control section 28 makes the image output section 26 transmit the projector-side luminance information via the image cable 4 (step S3: the transmission control step).

In response to the image output section 26 transmitting the projector-side luminance information, the image input section 34 receives the projector-side luminance information via the image cable 4, and stores in the main memory 33 (step S4).

In response the main memory 33 storing the projector-side luminance information, the display adjustment section 36 makes the lamp driver 315 adjust the luminance in the display image of the projector 3 in accordance with the projector-side luminance information (step S5 the display device-side display adjustment step).

According to the steps S1 through S5 described above, the user of the projection system 1 can perform the adjustment of the luminance in the display image of the protector 3 in conjunction with the adjustment of the luminance in the display image of the laptop PC 2 by operating the operation section 22.

According to the projection system 1 relating to the present embodiment, the following advantages can be obtained. 1. Since the adjustment of the luminance in the display image of the projector 3 can be performed in conjunction with the adjustment of the luminance in the display image of the laptop PC 2, the presenter of the presentation can easily adjust the luminance in the display image of the presentation. Further, since the presenter needs only to perform the adjustment of the luminance in the display image of the laptop PC 2, there is no need for learning an additional operation, thus the projection system 1 is accessible for the presenter.

2. Since the image cable 4 and the image output section 26 are adopted as the transmission section, no additional cable or the like is required for transmitting the luminance information. Therefore, the configuration of the projection system 1 can be simplified, thus the projection system 1 can be configured at low cost.

### Modified Example of Embodiments

It should be noted that the invention is not limited to the embodiment described above but includes modifications and improvements in a range where the advantages of the invention can be achieved.

Although in the above embodiment, the projector-side luminance information is communicated using the DDC/CI, it is possible to transmit the projector-side luminance information by, for examples combining with the image data signal using a frequency modulation method or the like, and it is just required to communicate the display device-side adjustment information between the image output device and the image display device.

Although in the embodiment the image cable 4 and the image output section 6 are adopted as the transmission section, a Universal Serial Bus (USB) cable, a network cable, and wireless network equipment, for example, can also be adopted. It is just required that the image output device and the image display device can be connected so that communication of information between the both devices is possible.

Although in the embodiment the PC-side luminance information is exemplified as the output device-side adjustment information, the PC-side image quality information, for example, can also be adopted. In this case, each of the display adjustment sections of the laptop PC 2 and the projector 3 needs only to make the respective image quality adjustment sections adjust the respective display images. It is just required that the output device-side adjustment information is information for adjusting a display condition of the image displayed by the output device-side display section.

Although in the embodiment described above the image output device is the laptop PC 2, it can also be, for example, a board computer or another projector. It is just required that the image output device can output image information.

Although in the embodiment described above the image display device is the projector 3, it can be, for example, a liquid crystal television set, and it is just required that the image display device displays the image corresponding to the image information.

In the embodiment described above, when the projector-side luminance information is stored by the main memory 33, the display adjustment section 36 makes the luminance in the display image of the projector 3 be adjusted. In contrast, the projector can be configured to be capable of switching between a coupled setting and an uncoupled setting, wherein the adjustment of the display condition of the image displayed by the output device-side display section and the adjustment of the display condition of the image displayed by the display device-side display section are performed in a coupled manner in the coupled setting, or not performed in a coupled manner in an uncoupled setting. Further, the display device-side display adjustment section can also be configured to adjust the display condition of the image displayed by the display device-side display section in accordance with the display device-side adjustment information only in the case in which the display device-side adjustment information is received in the condition in which the coupled setting is selected by the switching operation input from the user.

Although in the embodiment described above, the transmissive liquid crystal panel 312 is used, this is not the limitation. The reflective liquid crystal panels can also be adopted, or a digital micromirror device (DMD) can also be adopted. It should be noted that DMD is a trademark owned by the Texas Instruments (united States).

Although in the embodiment, the configuration provided with three liquid crystal panels 312 is adopted, this is not a limitation. A configuration provided with only one liquid crystal panel 312, a configuration provided with two liquid crystal panels 312, or a configuration provided with four or more liquid crystal panels 312 can also be adopted.

The present invention can be applied to an image display system, and in particular, preferably to a projection system using a projector.

The entire disclosure of Japanese Patent Application Nos: 2007-005117, filed Jan. 12, 2007 and 2007-248461, filed Sep. 26, 2007 are expressly incorporated by reference herein.

What is claimed is:

1. An image display system comprising:
an image output device for outputting image information;
an image display device for displaying an image corresponding to the image information; and
a transmission section that connects the image output device and the image display device to each other in a manner capable of transmission of information,
wherein the image output device includes
an output device-side display section that displays an image corresponding to the image information,
an output device-side control section that controls the output device-side display section, and
an operation section that allows input of an output device-side adjustment information for adjusting a display condition of an image displayed by the output device-side display section and outputs the output device-side adjusting information to the output device-side control section,
the output device-side control section having
an output device-side display adjustment section that makes a display condition of an image displayed by the output device-side display section be adjusted in accordance with the output device-side adjustment information, and
a transmission control section that generates display device-side adjustment information for adjusting a display condition of an image displayed by the image display device in accordance with the display condition adjusted by the output device-side display adjustment section in accordance with the output device-side adjustment information, and makes the display device-side adjustment information be transmitted by the transmission section, and
the image display device includes
an display device-side display section that displays an image corresponding to the image information, and
a display device-side control section that controls the display device-side display section,
the display device-side control section having
a display device-side display adjustment section that, in response to reception of the display device-side adjustment information, makes a display condition of an image displayed by the display device-side display section be adjusted in accordance with the display device-side adjustment information.

2. The image display system according to claim 1,
wherein the transmission control section generates the display device-side adjustment information in accordance with the output device-side adjustment information for adjusting luminance, and makes the display device-side adjustment information be transmitted by the transmission section.

3. The image display system according to claim 1,
wherein the image display device is a projector provided with a light source device, a light modulation device for modulating light emitted from the light source device in accordance with an image information to form an optical, image, and a projection optical device for enlargedly protecting the optical image thus formed.

4. An image output device used for an image display system including the image output device for outputting the image information, an image display device for displaying an image corresponding to the image information, and a transmission section that connects the image output device and the image display device to each other in a manner capable of transmission of information, comprising:
an output device-side display section that displays an image corresponding to the image information;
an output device-side control section that controls the output device-side display section; and
an operation section that allows input of an output device-side adjustment information for adjusting a display condition of an image displayed by the output device-side display section, and outputs the output device-side adjusting information to the output device-side control section,
the output device-side control section having
an output device-side display adjustment section that makes a display condition of an image displayed by the output device-side display section be adjusted in accordance with the output device-side adjustment information, and
a transmission control section that generates display device-side adjustment information for adjusting a display condition of an image displayed by the image display device in accordance with the display condition adjusted by the output device-side display adjustment section in accordance with the output device-side adjustment information, and makes the display device-side adjustment information be transmitted by the transmission section.

5. An image display method for displaying an image corresponding to image information, comprising:
(a) providing an image display system including an image output device for outputting the image information an image display device for displaying an image corresponding to the image information, and a transmission section that connects the image output device and the image display device to each other in a manner capable of transmission of information;
(b) the image output device adjusting a display condition of an image displayed by the image output device in accordance with output device-side adjustment information in response to input of the output device-side adjustment information for adjusting a display condition of an image displayed by the image output device;
(c) the image output device generating display device-side adjustment information for adjusting a display condition of an image displayed by the image display device in accordance with the display condition adjusted in step (b) in accordance with the output device-side adjustment information, and transmitting the display device-side adjustment information by the transmission section; and
(d) the image display device adjusting a display condition of an image displayed by the image display device in accordance with the display device-side adjustment information in response to reception of the display device-side adjustment information.
